(19) United States
(12) Patent Application Publication
(10) Pub. No.: US 2018/0060206 A1
(43) Pub. Date: Mar. 1, 2018

(54) CLOUD COLLABORATION AND MANAGEMENT APPLICATION

(71) Applicant: Alex Dworkin, Gloucester (CA)

(72) Inventor: Alex Dworkin, Gloucester (CA)

(21) Appl. No.: 15/686,243

(22) Filed: Aug. 25, 2017

Related U.S. Application Data
(60) Provisional application No. 62/379,833, filed on Aug. 26, 2016.

(51) Int. Cl. G06F 11/34; H04L 12/26; H04L 29/08; G06F 17/30; G06F 11/30

(52) U.S. Cl. CPC G06F 11/3409; H04L 43/50; G06F 11/3034; G06F 17/303; G06F 17/30283; H04L 67/1097

(57) ABSTRACT

Cloud storage solutions are provided, in which different cloud storage spaces are aggregated together from the viewpoint of a user. Embodiments of the cloud storage space monitoring and management application provide systems for effective cloud storage management and monitoring, including uploading files to a cloud storage space, downloading files to a user's personal computing device, and migrating/sorting files between different cloud storage spaces. The cloud storage space monitoring and management application will also provide an integrated user interface that displays digital information stored in or more cloud storage spaces, which may be provided by various cloud storage service vendors, in a single display.

### FIELD OF INVENTION

The present invention pertains to the field of cloud computing, and in particular, to methods and systems for monitoring and management of multiple cloud storage spaces.

### BACKGROUND

Cloud storage is a type of digital data storage in which the digital data is stored at a remote location, sometimes referred to as a virtual storage space. The physical storage space making up the cloud storage space can exist as multiple servers located across multiple regions or continents around the world. Details regarding the storage locations are typically abstracted from the end application. The physical environment of cloud storage is typically owned and managed by a hosting company. Cloud storage systems may be accessed over the internet, and have significantly increased efficiency and productivity at various work places as the users now have accessibility to remotely saved files from anywhere internet connectivity is available. Cloud storage systems also allow the user to set preferences, including sharing permissions. Permitting others to access to a particular section of a cloud storage system allows the user to share files with colleagues and/or clients. With the introduction of several cloud storage service providers, cloud storage service has exploded in popularity and is now part of day-to-day functions for many business entities and individuals.

With growing demand for cloud storage use, users have started to open accounts with multiple service providers. Many of these cloud storage services offer the use of their cloud storage space without cost. However the available free storage capacity that most cloud storage service providers offer is often quite limited. Cloud storage subscribers create additional cloud storage accounts in order to access cloud storage services with minimum or no cost.

When a user creates multiple cloud storage space service accounts, they may encounter several issues. For example, it is difficult for a user to choose the best suited cloud storage space, among many available cloud storage services when they tries to upload digital data. Each cloud storage service may have specific characteristics and capabilities that better suit the digital data that a user wishes to store within that cloud storage space. Gathering data required for an appropriate comparison of each cloud storage service is a significant burden. Each cloud storage service characteristic and capabilities are also prone to change, furthering the difficulty in this comparison. Even if all the data required for a user to complete a proper performance comparison is available, the user may not be able to make the best decision due to lack of professional knowledge.

Another common problem encountered by cloud storage service users is the unavailability of a unified and/or integrated view of the cloud storage space, which provides the user with the list that outlines the entirety of files stored in multiple cloud storage spaces. When a user is using more than one cloud services, they are able to view the files stored in only one of the cloud storage systems at one time. For example, if User 1 stored file A in cloud storage AA and file B in cloud storage BB, then User 1 will not be able to view both file A and file B in one window at the same time—the two files are saved in two different cloud storage systems.

When a cloud storage space user wishes to concurrently access several files stored in different cloud storage systems, they must open up several windows for each file. This method of finding and accessing digital data is inconvenient and reduces efficiency.

A cloud storage space user may store all digital data in one cloud storage space, however this limits the capacity of available storage, and may increase the cost of using the storage space. Alternatively the storage space user may transfer files from one cloud storage space to another in order to better organize specific digital data. However this method is onerous to users because in most cases the user must manually migrate digital data by downloading each piece of data from the original cloud storage space where the desired file is located, and transfer that data to the new targeted cloud storage space. This method may generate additional costs for network usage during data transfer.

Therefore there is need for an effective cloud storage space management application, capable of organizing and monitoring digital data, so that multiple cloud storage spaces may be viewed by the user within a single interface. There is also need for an application that is capable of monitoring and valuating the capabilities of multiple cloud storage spaces so that digital data may be optimally stored and then monitored within cloud storage space. There is also need for an application that completes cloud storage monitoring, digital data transfer and other cloud storage functions automatically.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a cloud collaboration and management application. In accordance with an aspect of the present invention, there is provided a computer-implemented system for management and monitoring of cloud storage spaces, the system comprising: at least one database that stores information required for communication with cloud storage spaces and a cloud storage space user; at least one user interface that displays digital information saved in one or more of the cloud storage spaces, and allows the user to interact with, select and manipulate the digital information; at least one operating module, comprising a microprocessor operatively coupled to memory, that performs one or more operations involving one or more of the cloud storage spaces, at least some of the operations selected from the group comprising: uploading, downloading, transferring, migrating, sorting, testing, monitoring, managing, analyzing, displaying digital information, and diagnostic testing; and the at least one database or at least one additional database storing information obtained during said one or more operations.

In accordance with another aspect of the present invention, there is provided a computer-implemented system for providing a cloud storage space user interface comprising: a display component configured to present users with digital information located in one or more cloud storage spaces; at least one database that stores gathered statistics from one or more diagnostic tests and operations involving the one or more cloud storage spaces; and a user interface configured to present to the cloud space storage user, via the display component, files stored in one or more cloud storage spaces.

In accordance with another aspect of the present invention, there is provided a computer-implemented method for sorting digital information stored in multiple cloud storage spaces comprising: storing, in at least one database, information required for communication with cloud storage spaces and a cloud storage space user; displaying, via at least one user interface, digital information saved in one or more of the cloud storage spaces, and allows the user to interact with, select and manipulate the digital information; performing, using at least one operating module comprising a microprocessor operatively coupled to memory, one or more operations involving one or more of the cloud storage spaces, at least some of the operations selected from the group comprising: uploading, downloading, transferring, migrating, sorting, testing, monitoring, managing, analyzing, displaying digital information, and diagnostic testing; and storing, in the at least one database or at least one additional database, information obtained during said one or more operations.

### BRIEF DESCRIPTION OF THE FIGURES

Embodiments of the present invention will be better understood in connection with the following figures, in which:

FIG. 1 is a flow diagram illustrating the overall process of digital data analysis, management, and upload to multiple cloud storage spaces;

FIG. 2 is a flow diagram illustrating a method for selection of an overall rating of a cloud storage space;

FIG. 3 is a table which illustrates how diagnostic data can be used to determine and rate the performance of each cloud storage space;

FIG. 4 illustrates a user interface dropdown menu; and

FIG. 5 illustrates an overall flow diagram of the cloud storage management system.

### DETAILED DESCRIPTION

### Definitions

The term “digital information” or “DI” is used to define information that may be stored within a digital storage medium such as but not limited to statistics, data files, video files, music files, picture files, software, documents, spreadsheets, or other information as would be understood by someone skilled in the art.

The term “personal communication device” or “PCD” is used to define a device capable of online communication, such as but not limited to a laptop computer, desktop computer, tablet, mobile phone, television, on-board vehicular computer or communication system, or other communication device as would be understood by someone skilled in the art.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Overview

The present invention provides systems and methods for monitoring and management of multiple cloud storage spaces. In one embodiment the cloud storage space monitoring and management application (also referred to herein as “CSM App”) may upload digital information to at least one cloud storage space (also referred to herein as “CSS”), download DI to the end user's local file system, analyze the performance of CSSs, support user requested DI operations in both local and cloud file systems and migrate, sort, and transfer DI between different CSS systems. The CSM App also provides an integrated user interface that displays a separate or a combined list of DI stored in one or more CSS in a single view pane. These CSSs may be provided by various cloud storage service vendors such as but not limited to Microsoft OneDrive™, Google Drive“, Amazon Cloud Drive”, Dropbox™, Box™, and Apple iCloud™.

In one embodiment, the at least one CSS may be a commercial cloud storage space or may be non-commercial cloud storage spaces. The at least one CSS may be publically or privately available. The user may utilize any number of CSSs to access within the CSM App.

In one embodiment, the CSM App may be accessed by a user on a PCD. The user will be able to utilize the functions of the CSM App through a PCD connected to the internet.

In one embodiment the CSSs may be connected to the CSM App through another type of network besides the internet. Each CSS vendor may provide open APIs for various purposes including identifying end-users and performing operations requested by users through networks.

In one embodiment, the CSM App could be installed and accessed on a user PCD, or using a web-based method. The user may mark certain DI as important and instruct the CSM system to deal with this important DI in some particular manner. For example financial documents may be marked as important, and these documents may be stored on multiple different CSSs for added safety and rapid retrieval. The process to determine where important DI should be stored may be governed by the rating system. The user may provide a minimum rating that a CSS needs to have achieved in order to be used as a backup location for the important DI.

In one embodiment, the CSM App may use CSSs like different redundant arrays of independent disks (also referred to herein as “RAID”) for added security or speed of access. The CSM App may distribute DI across several CSSs in one of several ways, depending on the required level of redundancy and performance, similar to the way data is distributed with RAID.

### Cloud Storage Management System

In one embodiment the cloud storage management (also referred to herein as “CSM”) system accesses at least one database to store information required for communication with CSSs and a CSS user. There is at least one user interface that displays DI saved within the CSSs and allows the CSM App user the ability to interact with, select and manipulate the DI. At least one operating module is provided which is configured to perform various operations within the CSM system. At least one database is provided which is configured to also store information required for system analysis.

In one embodiment the various operations performed by the operating module include, but are not limited to uploading, downloading, transferring, migrating, sorting, testing, monitoring, managing, analyzing, displaying DI, and diagnostic testing of CSSs.

In one embodiment the information required for system analysis stored within the at least one database includes, but is not limited to diagnostic testing information, usage patterns of a CSS user information, CSS characteristic information CSS operation information, and digital information.

In one embodiment, the CSM system is configured to use information collected within at least one database, and analyzed by at least one operating module, to select the most suitable CSS among one or more CSSs available, to perform an operation. For example, the CSM system may select the best suited CSS for the upload or download of DI as requested by a user. This selection may be displayed on the user interface.

In one embodiment, the CSM system is configured to use information collected within at least one database, and analyze using one or more operations within the operating module, to perform an operation requested by the user on the CSS. The operation and/or results of the operation may be displayed on the user interface.

In one embodiment, the CSM system is configured to use information collected within at least one database, and one or more operations used by at least one operating module, to allow the user communicate between the user PCD and CSSs. Information required for communication with may include, but is not limited to open application programming interfaces (APIs) of CSSs, and CSS user credentials.

In one embodiment the CSM system user may utilize multiple CSSs as a single storage space without needing to manage each individual CSS separately. The user is able to view and manage all DI stored within multiple CSSs, within a single viewer of the user interface. The CSM system combines multiple CSSs into a single space to provide an accumulated larger storage capacity. This is achieved without the user having to pay additional costs associated with using large CSS.

In one embodiment the CSM system is configured to utilize at least one operating module that performs various operations such as but not limited to uploading, downloading, transferring, migrating, sorting, testing, monitoring, managing, analyzing, displaying DI, diagnostic testing of CSSs and other operations as would be understood by someone skilled in the art. The operational modules may be enacted at the direction of the CSM APP user, automatically run by the CSM system, or may run as a background process.

In one embodiment the CSM system is configured to utilize at least one operating module (also referred to herein as a “file chooser”) which allows the user to select specific DI to upload to a CSS. The DI may be located in the local file system of the user's PCD. The DI may also be located in an external file storage space which can be accessed by the file chooser, either remotely or through the user PCD. The user may select whether or not the CSM App will utilize a file chooser.

In one embodiment the CSM system is configured to utilize at least one operating module (also referred to herein as a “file uploader”) that will upload DI selected by the user on a CSS. The CSS to which the DI is uploaded may be determined by another operating module within the CSM App. This determination may be made automatically by the CSM system, or manually by the CSM App user. For example the user may elect to upload specific DI to CSS“A” instead of CSS“B”, even though the CSM system has determined that CSS “B” will perform better according to the analysis of the CSM system.

### Data Collection Module

In one embodiment, the CSM system is configured to use one or more data collecting modules to gather and store data from other modules, as used within the operation of the system and CSSs. For example performance data for each metric may be gathered by a data collecting module from diagnostic tests. A data collecting module may also collect various data from each operation of CSS such as but not limited to file size, file name, uploading time, server response time, or otherwise as would be understood by someone skilled in the art.

### Diagnostic Module

In one embodiment, the CSM system is configured to use at least one diagnostic module to perform and control diagnostic testing for purpose of measuring performance of CSSs. The information used to perform these diagnostics may include, but is not limited to upload throughput, download throughput, server response time, jitter, remaining storage space and reliability of CSS.

In one embodiment the diagnostic testing may be performed using CSM system generated DI instead of CSS user DI. The diagnostic testing may be commenced at the direction of the CSM APP user, automatically run by the CSM system, or may run as a background process.

In one embodiment the CSM system is configured to use the diagnostic module to perform and control a diagnostic test with respect to the reliability of a CSS. This reliability measurement or jitter test may be executed by sending out a number of pings CSS servers. In this way the jitter for each CSS can be measured by calculating the value of the standard deviation for multiple server response times obtained through the pings sent to each corresponding CSS.

In one embodiment the CSM system is configured to use the diagnostic module to perform and control a diagnostic test with respect to CSS server response time. The CSS server response time may be measured by sending pings to CSS servers. The response time of a CSS may be obtained by calculating an average of response times for multiple pings sent to each corresponding CSS. The real-time response time of a CSS can be directly obtained by an open API that provides the current server response time of a CSS.

In one embodiment the CSM system is configured to use the diagnostic module to perform and control a diagnostic test with respect to measurement of upload throughput and download throughput. A small sample file of small capacity may be used for the measurement of upload throughput and download throughput of the CSS. The CSM system may upload and download the file of small capacity to each CSS, and then using the size of the file and the time spent for the completion of each task, calculate the upload or download throughput. A pure value of the time required for each task may be calculated by subtracting server response time. Individual tests may be completed many times over so that the system is able to determine an average download or upload throughput.

In one embodiment the CSM system is configured to use the diagnostic module to perform and control diagnostic tests for speed, throughput, jitter, and response from the user's PCD in order to accurately predict the specific user PCD experience.

### Monitoring Module

In one embodiment, the CSM system is configured to use one or more monitoring modules that monitor the usage pattern of the CSM App user, and the type of DI used. The monitoring modules may also monitor CSS upload speed, download speed, total capacities of each CSS, and remaining storage spaces of each CSS. The monitoring module may then provide information including, but limited to, whether the DI is more likely to be uploaded to a CSS or whether it is more likely to be downloaded from CSS. This information may be used by other modules in order to inform that modules function and performance. For example, monitoring module information may be provided to the rating module described herein, when it computes the performance of each CSS.

In one embodiment the monitoring module may monitor the usage of each DI file type and the operation most often used for that file type. The monitoring module may save this usage data in a database. When sufficient data related to DI is collected, the monitoring module on its own or with the aid of another module within the CSM App, may be able to determine the usage pattern of a particular user.

In one embodiment once the usage pattern has been determined, that information may be provided to another module. For example, usage information may be provided to the rating module. The rating module may then adjust the weighting of particular metrics used to determine the overall CSS rating, based upon the usage pattern. In this way the CSM system may draw a conclusion for selecting the best performing CSS.

### Rating Module

In one embodiment, the CSM system is configured to use one or more rating modules that substantively determine the most suitable CSS to perform user desired operations. The rating module may select the most suitable CSS based on a rating determined by a dynamic rating algorithm. The dynamic rating algorithm may be calculated using various information gathered by other modules including, but not limited to, the DI file type, real-time CSS performance with respect to a user requested operation, statistical performance of each CSS with respect to a user requested operation or otherwise as would be understood by someone skilled in the art.

In one embodiment the rating module may evaluate the performance of a CSS using diagnostic test results from another module of the CSM system. This evaluation may be used in determining the rating of a CSS.

In one embodiment of the rating module, performance of each CSS may be represented as a numeric value. Each numeric value rating representation may be provided as a range out of 5, where 1 is the poorest rating and 5 is the highest rating receivable. This rating may be developed by monitoring specific metrics as determined by the CSM App, and assigning a score to each metric. The overall performance rating of each CSS may be calculated by adding up each metric score of that CSS.

In one embodiment, the overall score of a CSS may be further manipulated by weighting each metric affecting that overall score. This weighted rating may be calculated by multiplying the original metric score with a proper scaling variable.

In one embodiment, the original metric score may be determined by comparing the real time performance of that metric with the average performance of the metric. The average performance of the metric may be determined from data previously collected and stored within the CSM system. In determining the original metric score, the better the real time performance of the metric is in comparison to the average performance of the metric, the higher the original metric score will be. Below is a sample calculation where each row represents the transformation of the original metric score into a final rating for a CSS.

The following are the metrics used: UT (upload throughput), DT (download throughput), RT (response time), J (jitter), AS (available space)
The format below is: Metric Name: Metric Score (Metric Weighting)

### UT: 5 (25%)=100% of 25% Weighting=25%

### DT: 5 (25%)=100% of 25% Weighting=25%

### RT: 1 (10%)=20% of 10% Weighting=2%

### J: 1 (20%)=20% of 20% Weighting=4%

### AS: 5 (20%)=100% of 20% Weighting=20%

Now the sum of the weighting percentages is calculated:
25%+25%+2%+4%+20%=76%
This final percentage is the overall rating that the CSS will receive. It may be displayed as a percentage score (as illustrated), or may be converted into the rating system as described herein. For example, a final score for the CSS of 76% could be converted into a 3.8 rating out of 5. The final rating may then be compared directly to other final scores of any other CSS being managed within the CSM system.

In one embodiment, the weighted rating may be further adjusted at the control of the user. The weighting importance of each metric may be denoted as percentage on the user interface. The user may adjust these percentages on the user interface to alter the weighting of individual metrics in the overall CSS rating. This user controlled ability to alter the importance of individual factors, will ensure the extent that each element's influence on the performance of CSS is properly reflected on the calculation of overall performance of the CSS. For example, a user may attempt to upload DI that is a ‘document’. The personal statistic information collected upon that user may indicate that a document type file is more likely downloaded than uploaded by that user. The user may be benefited if the document file is stored within a CSS that exhibits the best download performance as determined by the system. In this instance, the rating module put more weight on a metric related to download throughput than on a metric related to upload throughput.

In one embodiment the metrics used to determine CSS rating may be various factors including, but not limited to upload throughput, available space, download throughput, jitter, response time, and any other data gathered by a module (such as but not limited to the statistical data gathered by the data collection module). For example, the requirements for secure storage of sensitive information may be different from the requirements for reliable long-term storage of photos, which may be further different from the requirements for quickly accessible storage of music (e.g. which could be streamed straight from a CSS). Using alternative metrics to determine CSS rating will allow the CSM system to tailor the rating, in order to prioritize the CSS use in relation to DI requirements.

### User Interface

In one embodiment the CSM system may utilize at least one user interface that displays DI saved in various CSSs, and allows the CSM App user the ability to interact with, select and manipulate the stored DI.

In one embodiment the user interface will allow the user to interact directly with the CSM App. It may provide an integrated list and/or set of DI that the user has, or may wish to store on multiple CSSs. For example, the user interface may show a set of files from one or more CSSs as requested by the user. The interface may show files stored in CSS“A” only, or show files stored in CSS“A” and CSS“B” concurrently, or show files stored in all available CSSs currently used by the user.

In one embodiment, the CSM system user interface may provide the user with the ability to perform functions that support operations in a PCD or CSS. These functions may be, but are not limited to DI coping, pasting, cutting or otherwise as would be understood by someone skilled in the art. The user interface may also allow the user to perform functions that support communications between the PCD and the CSS, such as but not limited to uploading, download, entering credential information, or otherwise as would be understood by someone skilled in the art.

In one embodiment the CSM system is configured to sort DI stored in various CSS. The sorting operation may be operated periodically as scheduled or operated manually at user request. When the sorting operation is completed, DI stored in CSSs may be re-organized based on file names, file types, created times, file sizes, or any another DI characteristic as selected by the user. The DI may be migrated from one CSS to another based upon the sorting operation.

In one embodiment the user interface may provide a single folder designated for the use of the CSM system. The user may save and arrange DI in the designated folder to manage DI at their preference. A personalized file tree may be generated by the user and all DI within the designated folder may be uploaded into one of, or multiple CSSs that the user wishes to use. Each piece of DI may be automatically uploaded to the best suited CSS for that DI, as determined and selected by the CSM system modules.

In one embodiment the user interface may provide the user the ability to choose how they wish to view the DI within the CSM system. For example a user may elect to view a single a set of files stored in an individual CSS, or alternatively the user may elect to view a combined set of files stored in multiple CSSs.

In one embodiment the user interface may allow the CSM App user the ability to select how they wish to view DI stored in CSSs. The user interface may provide a window that shows a combined set of DI from all CSSs. The window may also show a combined set of DI from only some of the CCSs. The window may show DI that is stored in only one CSS.

### Database

In one embodiment the CSM system is configured to access at least one database to store information. The stored information may be recorded during any point of operation of the CSS or CSM App. This information may be accessed by the system at anytime. The information stored within the at least one database may include information required for communication between a CSS and a CSS user, identification information of a CSS, usage patterns of a CSS user, CSS characteristics, CSS operational data, upload speed, download speed, jitter, total remaining capacity of a CSS, DI location, DI identification, type of DI, size of DI, and other DI information as would be understood by someone skilled in the art.

In one embodiment the at least one database may be replaced by some other data storage mechanism, such as a spreadsheet or some other means for recording statistical data as would be understood by someone skilled in the art. This alternative data storage mechanism may be particularly important especially when an appropriate database is not available.

The invention will now be described with reference to specific examples. It will be understood that the following examples are intended to describe embodiments of the invention and are not intended to limit the invention in any way.

### EXAMPLES

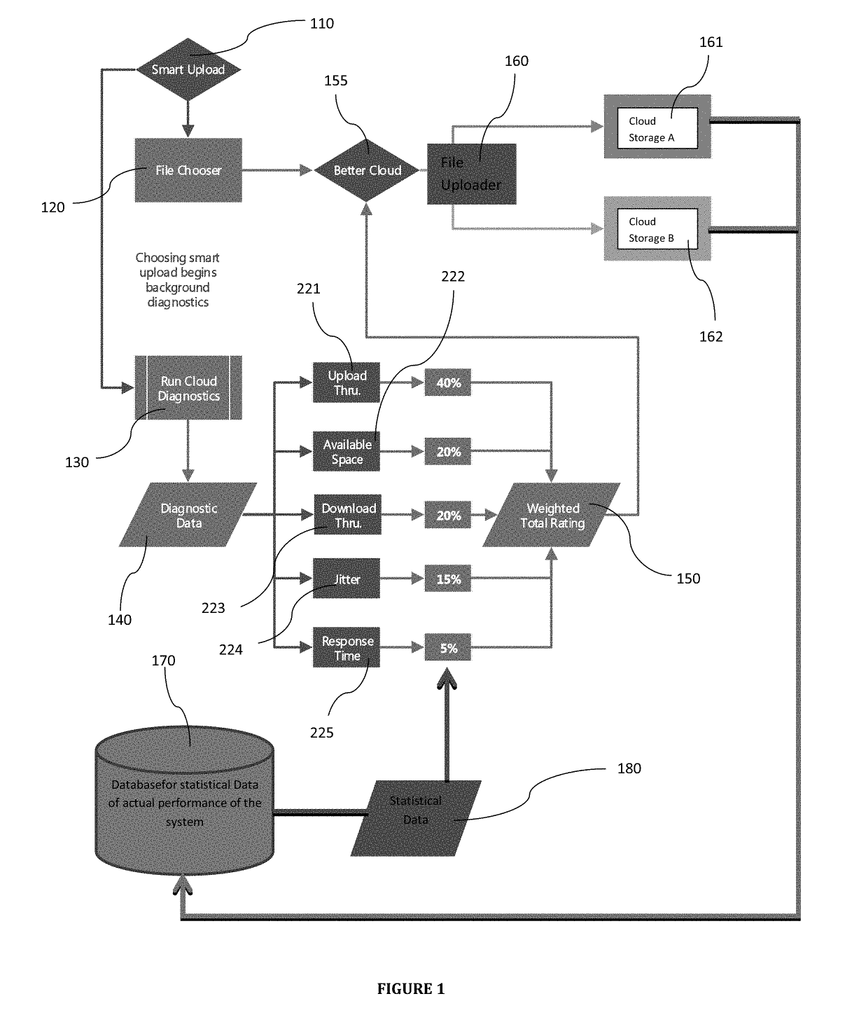

In one example as illustrated in FIG. 1, the upload of DI will begin 110. A diagnostic test of the CSSs may be run 130, and the diagnostic data, or metrics from those tests 140 such as upload throughput 221, available CSS capacity 222, download throughput 223, jitter 224, and response time 225 may be obtained. This data may then be analyzed and weighted to gain a total weighted rating of the CSS 150. Once the CSS total rating has been established, it can be used to determine the best CSS 155 on which to store DI. Alternatively a file chooser 120 may be able to select the best CSS 155 on which to store DI. Once the best CSS has been determined, the file uploader 160 can upload the DI to individual CSSs, such as CSS “A” 161, and CSS “B” 162. Data related to the performance of each CSS may be stored within a database 170. This stored data 180 may be used to inform the total rating of the CSS as well.

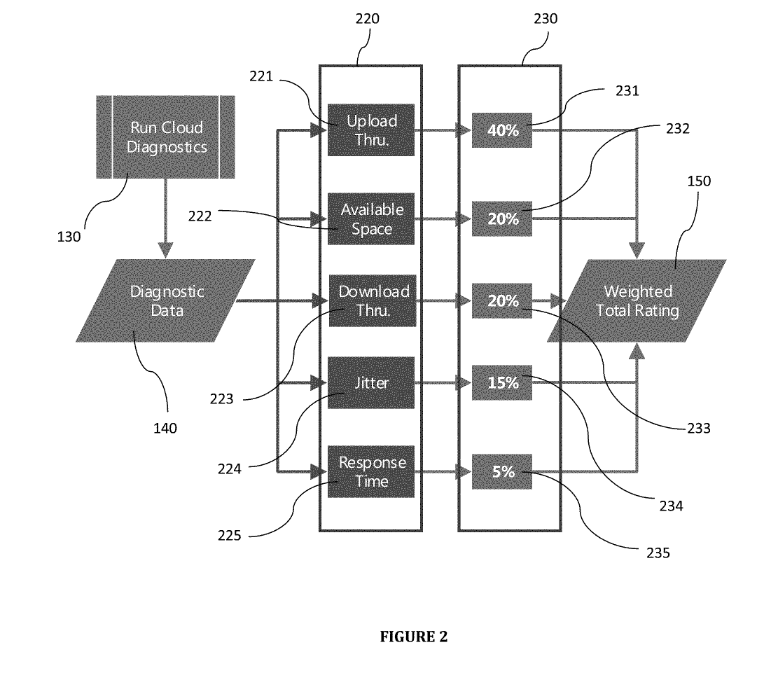

In one example as illustrated in FIG. 2, cloud diagnostics are run 130 within the CSM system. The diagnostic data 140 may be measured in different metrics 220 such as upload throughput 221, available space 222, download throughput 223, jitter 224, and response time 225. Each one of these metrics may be weighted in different percentages as scaling variables 230, such as 40% weighting for upload throughput 231, 20% weighting for available space 232, 20% weighting for download throughput 233, 15% weighting for jitter 234, and 5% weighting for the response time 235. Once these metrics are weighted the system will provide a weighted total rating 150 of the CSS.

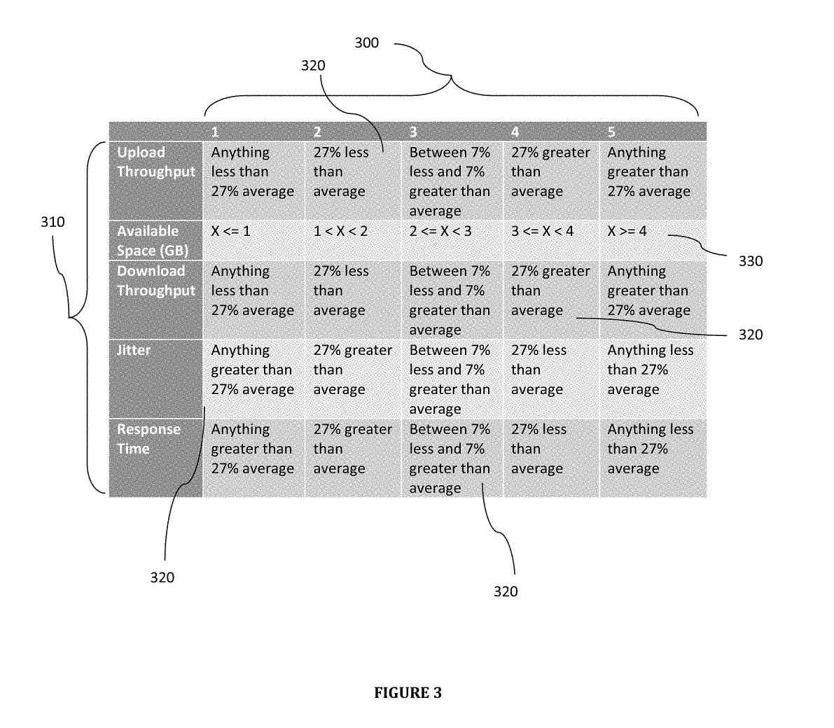

In one example as illustrated in FIG. 3, the rating score 300 may be determined by analyzing different metrics 310. A standard deviation 320 from the metric average performance may be used in order to determine a rating for each metric. A new full rating level may be achieved if the measured metric performance is a standard deviation away from the metric average. The rating for the available space metric is determined based upon the amount of provided space within a CSS 330.

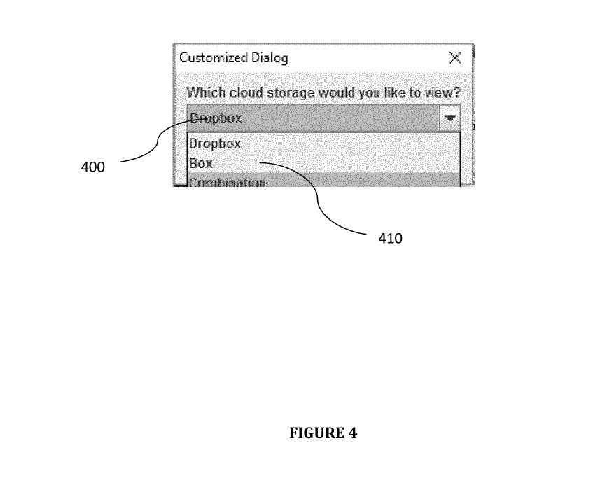

In one example as illustrated in FIG. 4, the user interface will allow the CSM App user the ability to select which CSS they wish to view. The dropdown box 400 provides options 410, from which the user can select. The user can select to view a single CSS at a time or a combination of CSSs.

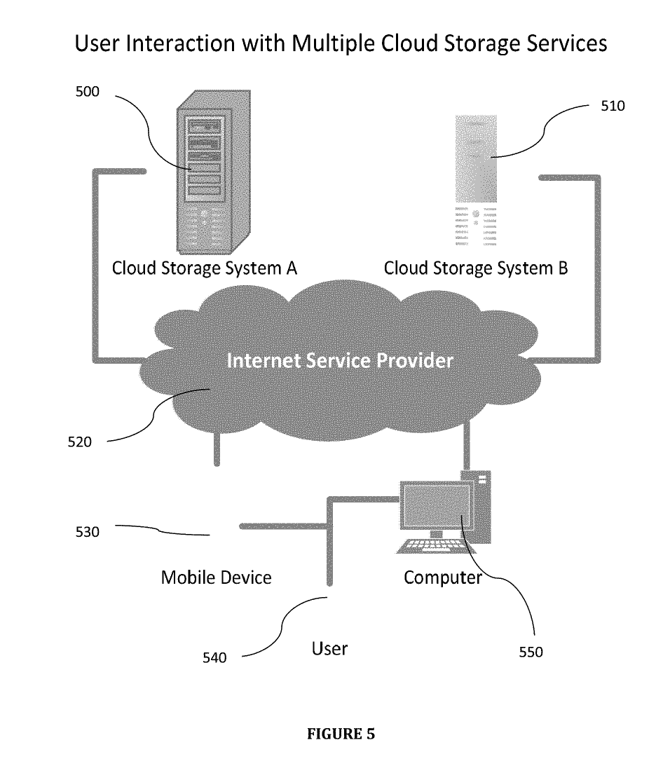

In one example as illustrated in FIG. 5, the CSM App user 540 may use a PCD such as a mobile device 530 or computer 550 with a microprocessor, memory, network interface and user interface to access cloud storage space. The user may access the servers of Cloud Storage System “A” 500 or a second Cloud Storage System “B” 510 through access to the Internet provided by an Internet service provider 520.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, personal communication device, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

The scope of the claims should not be limited by the preferred embodiments set forth in the examples, but should be given the broadest interpretation consistent with the description as a whole.

We claim:

1. A computer-implemented system for management and monitoring of cloud storage spaces, the system comprising:
at least one database that stores information required for communication with cloud storage spaces and a cloud storage space user;
at least one user interface that displays digital information saved in one or more of the cloud storage spaces, and allows the user to interact with, select and manipulate the digital information;
at least one operating module, comprising a microprocessor operatively coupled to memory, that performs one or more operations involving one or more of the cloud storage spaces, at least some of the operations selected from the group comprising: uploading, downloading, transferring, migrating, sorting, testing, monitoring, managing, analyzing, displaying digital information, and diagnostic testing; and
the at least one database or at least one additional database storing information obtained during said one or more operations.

2. The cloud storage space monitoring and management system of claim 1, wherein the information obtained includes one or more of: statistics from diagnostic tests, usage patterns of a cloud storage space user, cloud storage space characteristics, cloud storage space operations, and digital information.

3. The cloud storage space monitoring and management system of claim 1, further comprising one or more diagnostic modules that control said diagnostic tests in order to measure performance of one or more of the cloud storage spaces.

4. The cloud storage space monitoring and management system of the claim 1, further comprising one or more rating modules that determine a suitable cloud storage space for a predetermined digital information operation.

5. The cloud storage space monitoring and management system of claim 1, further comprising one or more data collecting modules that gather data from one or both of: the diagnostic testing; the operation s involving the one or more of the cloud storage spaces.

6. The cloud storage space monitoring and management system of claim 1, further comprising one or more monitoring modules that monitor the usage patterns of the cloud storage space user for digital information.

7. The cloud storage space monitoring and management system of claim 3, wherein at least one of the diagnostic tests performed by the diagnostic modules measures performance characteristics of one or more of the cloud storage spaces using real-time monitoring of upload throughput, download throughput, jitter and server response time.

8. The cloud storage space monitoring and management system of claim 7, wherein said at least one of the diagnostic tests is performed using system generated digital information rather than cloud storage space user digital information.

9. The cloud storage space monitoring and management system of claim 4, wherein the one or more rating modules convert performance characteristics of one or more of the cloud storage spaces into a numeric value.

10. The cloud storage space monitoring and management system of claim 4, wherein the one or more rating modules evaluate performances of one or more of the cloud storage spaces using diagnostic test results.

11. The cloud storage space monitoring and management system of claim 9, wherein the numeric value is adjusted based on usage pattern information provided by a monitoring module.

12. The cloud storage space monitoring and management system of claim 11, wherein the usage pattern information is developed by the monitoring module.

13. A computer-implemented system for providing a cloud storage space user interface comprising:
a display component configured to present users with digital information located in one or more cloud storage spaces;
at least one database that stores gathered statistics from one or more diagnostic tests and operations involving the one or more cloud storage spaces; and
a user interface configured to present to the cloud space storage user, via the display component, files stored in one or more cloud storage spaces.

14. The cloud storage space user interface system of claim 13, wherein the gathered statistics from one or more diagnostic tests and operations may include, but are not limited to, upload speed tests, download speed tests, determinations of total capacities of each cloud storages, and determinations of remaining spaces of each cloud services.

15. The cloud storage space user interface system of claim 13, wherein the user interface is operable by the cloud storage space user to conduct various activities including, but not limited to, one or more of: uploads, downloads, and coping and pasting of digital information stored in different cloud storage spaces.

16. The cloud storage space user interface system of claim 13, wherein the display component allows a user to view digital information located in one or more systems that are separately or remotely located from the cloud storage space user's personal computing device.

17. A computer-implemented method for sorting digital information stored in multiple cloud storage spaces comprising:
storing, in at least one database, information required for communication with cloud storage spaces and a cloud storage space user;
displaying, via at least one user interface, digital information saved in one or more of the cloud storage spaces, and allows the user to interact with, select and manipulate the digital information;
performing, using at least one operating module comprising a microprocessor operatively coupled to memory, one or more operations involving one or more of the cloud storage spaces, at least some of the operations selected from the group comprising: uploading, downloading, transferring, migrating, sorting, testing, monitoring, managing, analyzing, displaying digital information, and diagnostic testing; and
storing, in the at least one database or at least one additional database, information obtained during said one or more operations.

18. The implemented method for sorting digital information stored in multiple cloud storage spaces of claim 17, wherein the information obtained during one or more operations includes one or more of: statistics from diagnostic tests, usage patterns of a cloud storage space user, cloud storage space characteristics, cloud storage space operations, and digital information.
